(19) United States
(12) Patent Application Publication
(10) Pub. No.: US 2011/0236585 A1
(43) Pub. Date: Sep. 29, 2011

(54) METHOD TO PRODUCE A PHOTOCATALYTIC SURFACE, INCLUDING LAYERS OF SNO2 AND TIO2

(75) Inventors: David Stenman, Sala (SE); Veronica Nedelchef, Bromma (SE)

(73) Assignee: WALLENIUS WATER AKTIEBOLAG, Stockholm (SE)

(21) Appl. No.: 13/062,090

(22) PCT Filed: Sep. 2, 2009
(86) PCT No.: PCT/SE2009/050991

§ 371 Date: May 25, 2011

(30) Foreign Application Priority Data
Sep. 4, 2008 (SE) 0801905-1

(51) Int. Cl. B05D 1/36; B05D 3/02

(52) U.S. Cl. 427/380; 427/419.3

(57) ABSTRACT

A method of creating photocatalytic surfaces, includes the steps of creating a plurality of alternate layers of TiO₂ and SnO₂ on a carrier, wherein the SnO₂ layers are created from strongly basic solutions.

### TECHNICAL AREA

The present invention relates to a method for creating catalysts and in particular catalysts that are to be used in photo-catalytic processes.

### TECHNICAL BACKGROUND

Photocatalytic activity is a property displayed by many large bandgap semiconducting compounds and is defined as the ability of a material to transfer an electron from the valence band to the conduction band under exposure to ultraviolet radiation. This results in the formation of an electron-hole pair. Since the electrons in the conduction band show a moderate reduction potential and the holes in the valence band show a high oxidation potential, photocatalytic reactions are easily induced. This means that activated oxygen species such as hydroxyl radicals or superoxide radicals, can be generated on the surface by oxidation of hydroxide by the hole or by reduction of the dissolved oxygen in the solution, respectively. The resulting free radicals are very efficient oxidizers of organic matter, whereby reaction with organic substances generate new radical species in a chain reaction scheme.

One of the most commonly used large bandgap semiconductor materials is titanium oxide. Compared to other commonly used photocatalytic semiconductors, TiO₂ is close to being an ideal photocatalyst in several aspects such as being inert, corrosion resistant, inexpensive, chemically stable, the photogenerated holes are highly oxidizing and it may be considered as non-toxic. There are however also some drawbacks with TiO₂ such as photoreactions operate most efficiently under UV-light rather than visible light, whereby operating costs increase, nano-particle morphologies can be challenging to handle and recovery for reuse is difficult and control of surface structures and states are not easily achieved.

The overall quantum efficiency of the TiO₂ process is usually below 5% and therefore much research effort has been spent on increasing the efficiency of the process. Apart from the initial substrate concentration, several other physical parameters complicate an optimization of the photocatalytic efficiency. This includes among other effective surface area, irradiation source and wavelength of emission, temperature, radiation flux and quantum yield.

Various methods have been developed to enhance the photocatalytic activity (PCA). These include adsorption of noble metals on the TiO₂ surface, increasing the TiO₂ surface area and preparation of semiconductor alloys. However, one of the most promising methods includes the use of coupled semiconductor particles. Through a reduction of the charge recombination in photocatalytic systems the PCA can be increased. One of the most successful coupled semiconducting systems is the two-component coupled SnO₂/TiO₂ system. Both are large bandgap semiconductors but the energy of the conduction band for SnO₂ is lower than that of TiO₂. The method is based on an accumulation of photogenerated electrons in the conduction band of SnO₂. Since the holes move in the opposite direction they will be trapped in the TiO₂. Therefore the charge separation increases and the rate of recombination is reduced.

The improvement of the PCA in the coupled SnO₂/TiO₂ system is a direct consequence of the existence of more adsorption sites than those exhibited by the TiO₂ thin films alone. The optical bandgap decreases with the tin content and the absorption of larger wavelengths will favour the generation of more electron-hole pairs.

### BRIEF DESCRIPTION OF THE INVENTION

The aim of the present invention is to create catalytic surfaces displaying improved properties in comparison with the state of the art technology.

This aim is obtained by a method according to the independent patent claim. Preferable embodiments of the invention form the subject of the dependent patent claims.

According to a main aspect of the invention it is characterised by a method of creating photocatalytic surfaces, comprising the steps of creating a plurality of layers of TiO₂ and SnO₂ on a carrier, wherein the SnO₂ layers are created from strongly basic solutions.

According to alternate

According to another aspect of the invention, said strongly basic solution has a pH of 14.

According to yet an aspect of the invention, the layers of TiO₂ were created by coating with a Ti[OCH(CH₃)₂]₄ solution.

According to a further aspect of the invention, the SnO₂ layers were created by coating with a Sn²⁺ solution.

According to yet an aspect of the invention, it further comprises the step of putting said carrier in a heated oven after the each coating.

Preferably the temperature in said oven is in the range 450-600° C., and most preferably the temperature in said oven is 500° C.

According to another aspect of the invention, the carrier was placed in the heated oven for approximately one hour for each layer.

Preferably the outermost layer is of TiO₂.

There are a number of advantages with the present invention. Because the catalysts are formed by a plurality of layers of TiO₂ and SnO₂ a higher photocatalytic activity compared to catalysts only containing TiO₂ is obtained. Due to the strong pH of the solutions for creating the SnO₂ layers, a good adherence was obtained, which otherwise is a problem.

Preferably a Sn²⁺ solution is used which is not so expensive and/or hazardous as organic Sn-solutions. After creating the layers, preferably after each layer, the carriers are put in an oven at a temperature in the range of 450-600° C. Regarding titania the temperature range is chosen such that the crystalline polymorph anatase is created, which has a higher photocatalytic activity than the crystalline polymorph rutile.

The carriers were preferably kept in the oven for approximately one hour in order to ensure the complete formation of the layers. The outermost layer is preferably TiO₂ since it seems that SnO₂ is not as stable as a TiO₂ layer, and that an outermost TiO₂ layer protects the SnO₂ layer inside.

These and other aspects of and advantages with the present invention will become apparent from the following detailed description of the invention.

### DETAILED DESCRIPTION OF THE INVENTION

The present invention comprises a method of preparing photocatalytic surfaces in order to increase the catalytic effect. According to the method carrier members such as plates, nets and other appropriate surfaces are prepared in certain ways, as will be described. The carrier members could be of metal such as aluminium, titanium, stainless steel, brass copper, and other metal alloys but it is to be understood that other types of material could be appropriate, such as glass ceramics for example, as long as they can withstand high temperatures and the chemistry involved, as will be described below.

The carriers were washed, for example in cold water, and dried to make sure that the surfaces were as clean as possible. It is to be understood that other liquids could be used for washing the carriers. The drying could for example be made in a drying oven. All carriers were then pre-treated in a furnace for 1 hour at 500° C.

The carriers were then washed and preferably scrubbed mechanically in cold water, and dried in ambient air, or for example in an oven. After cooling of the carriers they were dip-coated in a solution consisting of Ti[OCH(CH₃)₂]₄. The carriers were all withdrawn at a speed of 2 mm/s and dried in ambient atmosphere for about 5 minutes. By then, a gel-coating film had formed.

The carriers were put into the furnace, 1 hour at 500° C. The temperature is chosen such that the crystalline polymorph of titania anatase is created. In this respect the temperature could be in the range of 450-600° C. for creating anatase. After that the carriers were washed in cold water and scrubbed mechanically in order to remove all unattached titania. The carriers were again dried in the furnace at 500° C. and cooled to room temperature before dip-coated again.

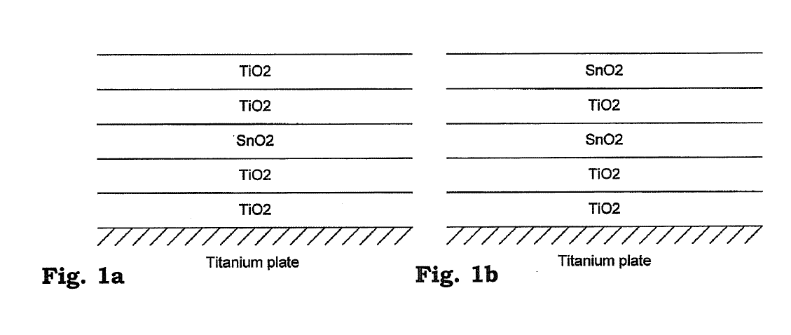

Apart from the above solution, a solution consisting of Sn²⁺ was prepared by dissolving SnCl₂ in a strong basic solution at a pH of 14. The carriers were then dipped in the tin-containing solution, put in the furnace at 500° C. for 1 hour and then cooled, washed and scrubbed. The procedure was repeated a number of times building up a plurality of layers of TiO₂ and SnO₂, as seen in FIGS. 1a and 2. By this method coupled semiconductor systems were obtained.

The PCA of these coupled semiconductor systems have been measured and compared to more conventional photocatalytic members containing for example only TiO₂, and it has been proved that the coupled semiconductor systems were more efficient than TiO₂ only. It has further been indicated during tests that the more layers of SnO₂, the higher activity. This may be due to a charge separation that occurs between the contacted pairs of TiO₂ and SnO₂ and therefore the recombination rate will be suppressed. It has also been indicated that it is advantageous to have the outermost layer of TiO₂ and not SnO₂, indicating that the SnO₂ surface may not be stable and it is possible that SnO₂ is dissolved.

An alternative method of applying the layers has also been evaluated. Here the carriers were washed before the coating process. The carriers were then dip-coated in Ti[OCH(CH₃)₂]₄ and withdrawn at a speed of 2 mm/s. Directly after this the carriers were put in the oven at 90° C. for 15 minutes. This procedure was repeated five times for five layers, and after the fifth coating the carriers with layers were put into the oven at 500° C. for one hour. The catalysts were then brushed in cold water in order to remove any unattached titania.

It is of course also possible within the scope of the present invention to prepare the layers of the catalysts by utilizing several other methods such as physical vapour deposition (PVD), chemical vapour deposition (CVD), anodic oxidation, sputtering, thermal composition and arc-plasma spraying.

Within the scope of the present invention, it is of course possible to replace the heating steps including the oven with other heat sources such as e.g. hot air guns, infra-red heaters or heat coils or the like heating methods and sources.

It is further to be understood that the method described above is to be regarded as a non-limiting example of the invention and that it may be modified in many ways within the scope of the patent claims.

1. Method of creating photocatalytic surfaces, comprising the steps of:
creating a plurality of layers of TiO₂ and SnO₂ on a carrier, wherein the SnO₂ layers are created from strongly basic solutions.

2. Method according to claim 1, wherein said strongly basic solution has a pH of 14.

3. Method according to claims 1, wherein the layers of TiO₂ were created by coating with a Ti[OCH(CH₃)₂]₄ solution.

4. Method according to claim 1, wherein the SnO₂ layers were created by coating with a Sn²⁺ solution.

5. Method according to claim 1, further comprising the step of putting said carrier in a heated oven after the each coating.

6. Method according to claim 5, wherein the temperature in said oven is in the range 450-600° C.

7. Method according to claim 5, wherein the temperature in said oven is 500° C.

8. Method according to claim 5, wherein the carrier was placed in the heated oven for approximately one hour.

9. Method according to claim 1, wherein the outermost layer is of TiO₂.

10. Method according to claims 2, wherein the layers of TiO₂ were created by coating with a Ti[OCH(CH₂)₂]₄ solution.

11. Method according to claim 2, wherein the SnO₂ layers were created by coating with a Sn²⁺ solution.

12. Method according to claim 3, wherein the SnO₂ layers were created by coating with a Sn²⁺ solution.

13. Method according to claim 2, further comprising the step of putting said carrier in a heated oven after the each coating.

14. Method according to claim 3, further comprising the step of putting said carrier in a heated oven after the each coating.
